(19) United States
(12) Patent Application Publication
(10) Pub. No.: US 2005/0047287 A1
(43) Pub. Date: Mar. 3, 2005

(54) Focus control

(76) Inventor: Darwin Mitchel Hanks, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/652,005

(22) Filed: Aug. 29, 2003

(51) Int. Cl. G11B 7/00

(52) U.S. Cl. 369/44.26

(57) ABSTRACT

A method of focus control is disclosed. In a passing action, a light source beam is passed over a reflectivity change on a storage media and on to a leading photo sensor and a trailing photo sensor. In a determining action, it is determined whether the leading photo sensor or the trailing photo sensor had a first change in reflectivity. If the leading sensor experienced the first change in reflectivity, then, in an adjusting action, a focus actuator is adjusted to move a focus lens farther from the storage media. If the trailing sensor experienced the first change in reflectivity, then, in another adjusting action, the focus actuator is adjusted to move the focus lens closer to the storage media.

Data, audio, and video information are increasingly stored on media such as compact discs (CD's) and digital versatile discs (DVD's). Various formats for storage of such data exist, such as CD-R, CD-RW, DVD-ROM, DVD+R, DVD-R, DVD+RW, and DVD-RW. Despite the differences in formats, however, storage devices which contain or are able to accept the various storage media often use a light source, such as a laser or high-power light-emitting diode, to read and/or write data on the storage media.

Data storage media such as CD's and DVD's contain several layers. For example, a substrate layer, often made of polycarbonate, is used to support a reflective layer. The reflective layer may have differences in reflectivity based on the properties of the layer itself (for example if the layer contains dyes which may be photo-activated). The reflective layer may also have differences in reflectivity which result from the conformation of the reflective layer to variations which have purposely been made in the substrate layer during a manufacturing process. Differences in reflectivity may also be caused by a combination of reflective layer properties and the topographical properties of the substrate where the substrate layer is coupled to the reflective layer. A protective layer, of acrylic for example, is often applied over the reflective layer. A label layer may be silk-screened or otherwise applied onto the protective layer.

Devices which may accept storage media, such as CD's or DVD's, often have an optical system which allows the light source to shine through the substrate side and onto the reflective data layer. The light then selectively or variably reflects back to a light sensor depending on the data state for each given data location on the surface of a storage medium. The size of a given data location is determined, in part, by the size of the light source spot which can be focused onto the storage medium. Many storage media readers and writers have a type of astigmatic focus error detection built into the optical path and control electronics in order to enable a suitable control over the focused spot size from the substrate side. As such, a spherical aberration is typically built into an objective focusing lens of the optical system to correct for the spherical aberration caused by the light passing through the medium substrate while performing a data reading and/or writing operation.

While the substrate side of a storage medium may be referred to as the data side of the medium or disc, it may also be desirable to read data from the label side of the disk, provided the label does not entirely block the light source. Unfortunately, while the astigmatic focusing process and system works well when reading or writing to media on the data side of the disc, it may encounter difficulties when trying to read or write data from the label side of the disc. Such difficulties arise due to lack of sufficient reflectivity of the disc and excessive surface roughness of the disc on the label side. This excessive roughness can cause scattering of light and distortion of the light wavefront arising from the fact that the spherical aberration correction built into the focusing lens is no longer cancelled by the spherical aberration arising from light traveling through the disc substrate as would be the case on the data side of the disc, or some combination thereof.

Despite difficulties focusing a light source from the label side of the disc, there is an increased interest in enabling existing optical architectures to focus a light source from the label side of a disc not only on the reflective data layer, but also or exclusively on the label surface itself. By enabling focus on the label layer, a light sensitive label material could be written to in such a way that custom labels on a disc could be imaged directly with the storage media light source. An example of a suitably light sensitive label material is disclosed in World Intellectual Property Application No. WO 03/032299 A2, entitled “Integrated CD/DVD Recording and Labeling”. Therefore, there exists a need for a suitable error focus generation technique which enables a label-side light source to focus on the storage media label and/or the storage media data layer without requiring a new optical path design.

### BRIEF DESCRIPTION OF THE DRAWINGS

FIG. 1 schematically illustrates one embodiment of a storage media drive optical path and control system for reading and writing data on storage media such as CD's and DVD's from the substrate side of the storage media.

FIG. 2 schematically illustrates one embodiment of a quadrature light sensor which may be used in an astigmatic focus scheme.

FIG. 3 schematically illustrates one embodiment of a storage media drive optical path and control system for reading and writing data on storage media such as CD's and DVD's from the label side of the storage media.

FIG. 4 schematically illustrates one embodiment of writing a label on storage media, such as CD's and DVD's, from the label side of the storage media using the embodiment of FIG. 3.

FIG. 5 schematically illustrates one embodiment of a storage medium having one embodiment of a feature of reflectivity change.

FIGS. 6A-7B schematically illustrate embodiments of a storage media drive where the objective focusing lens may be adjusted such that the spot size on the storage medium may be varied.

FIGS. 8A-8B schematically illustrate one embodiment of a storage media drive where the objective focusing lens is adjusted to provide a substantially minimized spot size on the storage medium.

FIG. 9 schematically illustrates one embodiment of timing signals within a storage media drive.

FIG. 10 illustrates one embodiment of actions which may be used to achieve a desired spot size on a storage medium.

FIG. 11 illustrates one embodiment of actions which may be used to achieve a substantially minimized spot size on a storage medium.

### DETAILED DESCRIPTION OF THE PREFERRED EMBODIMENTS

Electronic devices are increasingly equipped with disc drives which can read and/or write data on storage media such as CD's and/or DVD's. These electronic devices may include, for example, desktop computers, notebooks, tablet computers, video and audio component equipment, televisions, video game stations, portable audio and video devices, external and internal storage devices, digital cameras, digital video cameras, digital photo equipment which produces or interfaces with a photo disc, and vending machines.

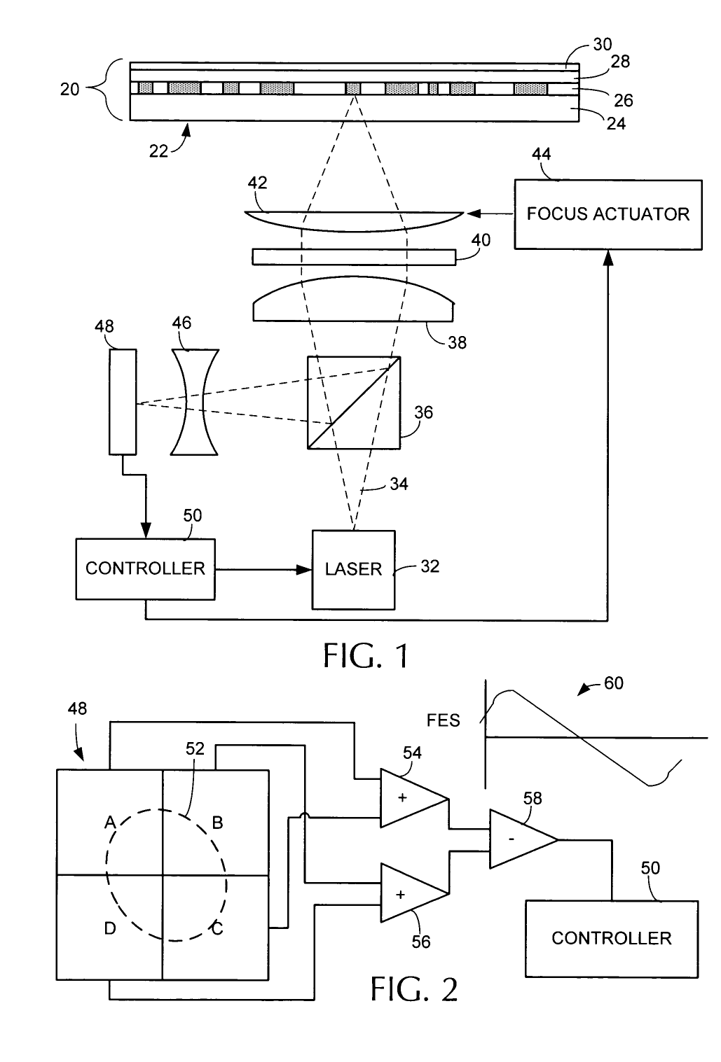

FIG. 1 schematically illustrates one embodiment of a storage media drive optical path and control system for reading and/or writing data on a storage media 20 such as a CD or a DVD from the substrate side 22 of the storage media 20. For the purpose of this disclosure, the term ‘media’ may refer to a single medium or media in the plural sense. The storage media may have a substrate layer 24, a reflective data layer 26, a protective layer 28, and a label layer 30. In order to read and/or write data on the storage media 20, a light source, such as laser 32 is focused onto the data layer 26 of the storage media 20. While a laser 32 is used in the embodiment of FIG. 1, other embodiments may utilize alternative light sources, such as a high-power light emitting diode. The laser 32 may be grated to create one or more spots which can be focused onto the storage media 20. The embodiments described herein use one focused spot, however, it should be appreciated that gratings for multiple spots could also be used. The laser light 34 passes through a polarizing beam splitter 36 and into a collimator lens 38. The collimated light then makes a first pass through a quarter wave plate 40, which changes the phase of the laser light by ninety degrees. An objective lens 42 focuses the laser light onto the storage media 20. A focus actuator 44 is coupled to the objective lens 42, and is able to adjust the objective lens 42 towards and away from the storage media 20.

Depending on the reflectivity of the data layer 26, varying amounts of laser light 34 may reflect off of the data layer 26 and back through the objective lens 42 and to the quarter wave plate 40, where the phase of the reflected light is rotated an additional ninety degrees. This second pass through the quarter wave plate results in a reflected light passing backwards through the collimator lens 38 which is one-hundred eighty degrees out of phase with the original laser light 34. As a result, when this phase-shifted reflected light reaches the polarizing beam splitter 36, it is reflected through an astigmatic cylindrical lens 46 and onto a photo sensor 48. A controller 50 is coupled to the photo sensor 48, and allows light sensed at the photo sensor 48 to be analyzed. Analysis of the light can include determination of whether the light beam is properly focused and the light level being received at the photo sensor 48. The controller 50 may include analog circuitry, digital circuitry, an application specific integrated circuit (ASIC), a microprocessor, or any combination thereof. The controller 50 is coupled to the laser 32, and may control when the laser 32 is emitting light and at what intensity. The controller 50 is also coupled to the focus actuator 44, for the purpose of adjusting the position of the objective lens 42 to achieve a desired focus or spot size on the storage media 20. A focus error signal is typically generated by the photo sensor 48 and the controller 50 in order to drive the desired focus.

FIG. 2 schematically illustrates one embodiment of a quadrature photo sensor 48 which may be used in an astigmatic focus scheme. The photo sensor 48 may be divided into quarters, here illustrated as quadrant A, quadrant B, quadrant C, and quadrant D. Each quadrant has the ability to measure incident light independent of the others. The astigmatic cylindrical lens 46 from the optical path of FIG. 1 has different focal lengths in two perpendicularly intersecting planes. A spot projected through this cylindrical lens 46 will vary in shape from a tall ellipse, to a circle, to a wide ellipse, depending on the position of the objective lens 42 relative to the reflective data layer 26. FIG. 2, schematically illustrates an incident light spot 52 contacting the quadrants of the photo sensor 48. By summing 54 quadrants A and C, summing 56 quadrants B and D, and feeding the difference 58 to the controller 50, a focus error signal 60 may be observed. If the focus error signal 60 is positive, the objective lens 42 is too close, and the controller 50 may instruct the focus actuator 44 to pull the objective lens 42 back until the focus error signal 60 is substantially equal to zero. If the focus error signal 60 is negative, the objective lens 42 is too far, and the controller 50 may instruct the focus actuator 44 to push the objective lens 42 closer until the focus error signal 60 is substantially equal to zero. An astigmatic focus error detection scheme, such as the one illustrated in FIG. 2 works well when reading or writing data from the substrate side 22 of a storage media 20.

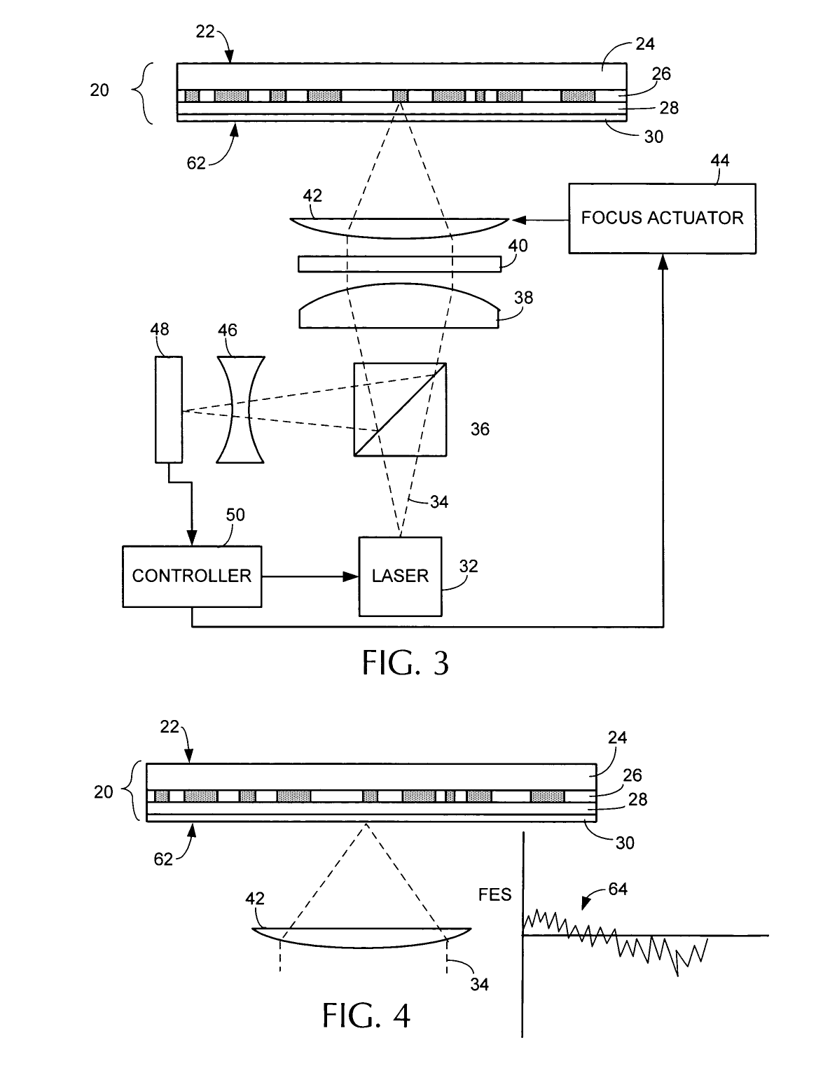

FIG. 3 schematically illustrates one embodiment of a storage media drive optical path and control system for reading and writing data on storage media such as CD's and DVD's from a label side 62 of the storage media 20. With the exception that the storage media 20 is flipped over, the optical path of the embodiment in FIG. 3 is identical to the optical path of the embodiment in FIG. 1. Laser light 34 may be focused onto the data layer 26, through the label layer 30 and the protective layer 28, and reflected back to the photo sensor 48.

As FIG. 4 illustrates, the laser light 34 may also be focused on the label layer 30. Unfortunately, one or more of several factors make the embodiments illustrated in FIGS. 3 and 4 difficult to focus, due to poor focus error signal generation. Such factors include a lack of sufficient reflectivity on the storage media 20 when approached from the label side 62 and excessive surface roughness on the label side 62. The surface roughness may cause scattering of light, distortion of the light wavefront arising from the fact that the spherical aberration correction built into the focusing lens 42 is no longer cancelled by the spherical aberration of the light passing through the substrate 24, or some combination thereof. In fact, the resultant focus error signal, when approaching the storage media 20 from the label side 62 may be extremely noisy, as illustrated by the noisy focus error signal 64 of FIG. 4.

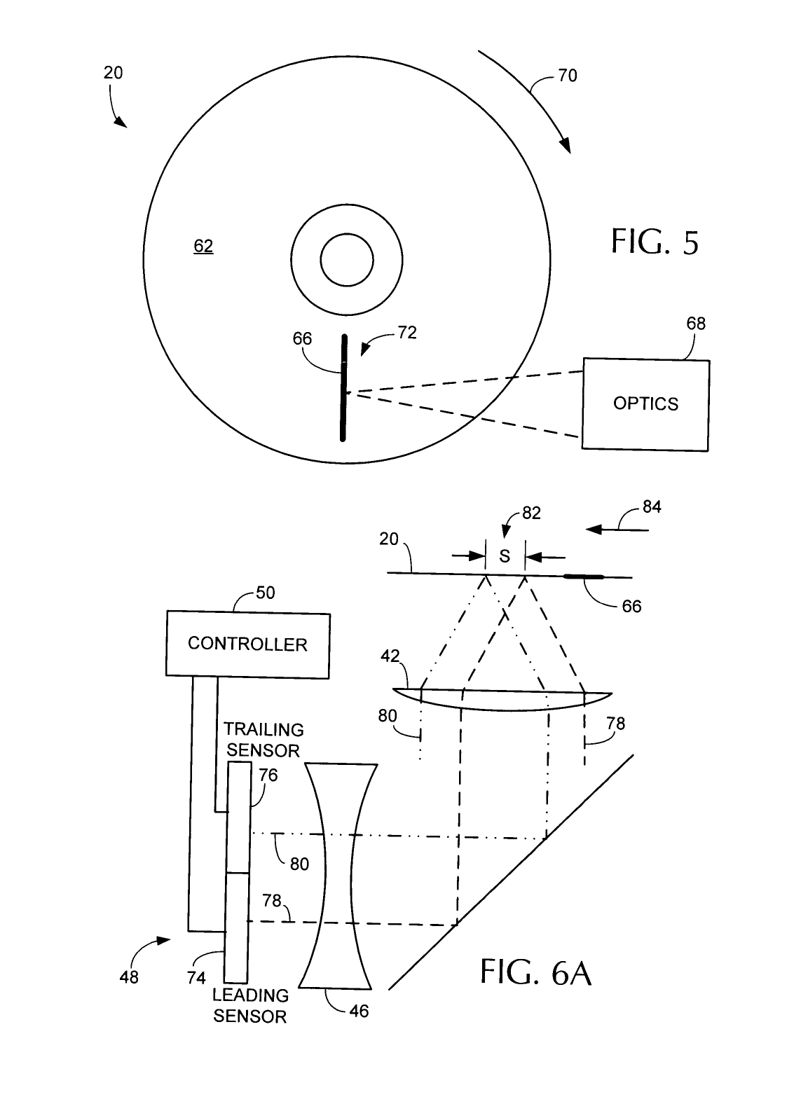

FIG. 5 schematically illustrates one embodiment of a storage media 20 having one embodiment of a feature of reflectivity change 66. The feature of reflectivity change 66 is constructed as part of the storage media 20 such that it is visible to the optics system 68 from the label side 62 of the storage media 20. The feature of reflectivity change 66 illustrated in FIG. 5 is a non-reflective bar which will be visible to the optics system 68 as the storage media 20 rotates 70. The schematic illustration of FIG. 5, like the other schematic illustrations in this disclosure, is not drawn to scale. The feature of reflectivity change 66 may extend over a small portion of the storage media 20, or over a large portion of the storage media 20. In other embodiments, the feature of reflectivity change 66 may take on other patterns, such as several stripes, blocks, or even a checkerboard type of pattern. The feature of reflectivity change 66 may be non-reflective, partially reflective, or more reflective as compared to the surrounding areas which are made of a different reflectivity. The feature of reflectivity change 66 may be present in the label layer 30 of the storage media 20, the data layer 26, or both, provided the optics system 68 can sense the desired feature of reflectivity change 66.

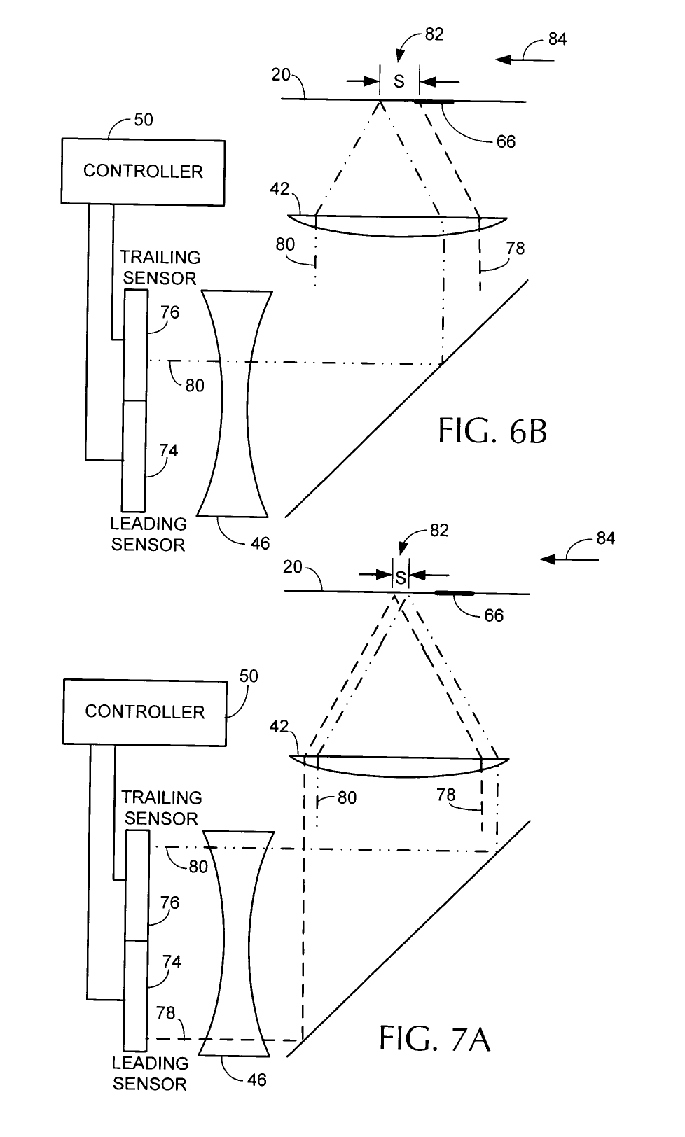

A storage media 20 having a feature of reflectivity change 66 can be read, written-to, or imaged from the label side 62, despite the lack of a suitable astigmatic focus error signal 60, such as the one illustrated in FIG. 2. As schematically illustrated in the embodiment of FIG. 6A, pairs of photo sensors on the quadrature photo sensor 48 may be divided into a leading photo sensor 74 and a trailing photo sensor 76. From the partial optical path illustrated in FIG. 6A, the leading edge 78 of the light beam, as well as the trailing edge 80 of the light beam can be seen passing through the objective focusing lens 42, and contacting the storage media 20. For simplicity, the layers of the storage media 20 are not illustrated in FIG. 6A. It should be understood, however, that the apparatus and methods described herein are applicable to focusing the light beam onto the label layer 30 and/or the data layer 26 of the storage media 20. The light 78, 80 reflected from the storage media 20 passes back through the objective lens 42 and eventually contacts the photo sensors 74, 76. In this case, the leading edge 78 of the light beam contacts the leading photo sensor 74, and the trailing edge 80 of the light beam contacts the trailing photo sensor 76.

Depending on the proximity of the objective focusing lens 42 to the storage media 20 and the focal length of the lens 42, a light source spot 82 will have a varying spot size, S. The focused image of the light source spot 82 will be non-inverted if the distance from the focus lens 42 to the storage media 20 is less than the focal length of the lens 42. Conversely, the focused image of the light source spot 82 will be inverted if the distance from the focus lens 42 to the storage media 20 is greater than the focal length of the lens 42.

The feature of reflectivity change 66 is illustrated on the storage media 20 in the embodiment of FIG. 6A. The storage media 20 is moving in the direction 84, relative to the light source spot 82. At the point in time which FIG. 6A illustrates, no information regarding the focus error signal is available. However, once the feature of reflectivity change 66 comes into contact with the light source spot 82, as schematically illustrated in the embodiment of FIG. 6B, information regarding the focus of the media storage drive can be determined. In the embodiments described herein, the feature of reflectivity change 66 is a non-reflective region compared to the surrounding regions for the ease of explanation. However, other embodiments may have a feature of reflectivity change 66 which has a lowered or increased reflectivity when compared to the surrounding areas. In the embodiment of FIG. 6B, where the feature of reflectivity change 66 has come into contact with light source spot 82, the non-reflective nature of the feature of reflectivity change 66 causes a change in the measured light signal present at the leading photo sensor 74, prior to any change in the measured light signal present at the trailing photo sensor 76. This indicates that the light source spot 82 is not inverted, and therefore the objective focus lens 42 is closer to the storage media 20 than the focal length of the lens 42. The size, S, of the light source spot 82 may be determined by dividing the time between sensed reflectivity change of the lead photo sensor 74 and reflectivity change of the trailing photo sensor 76 by the velocity of the storage media 20 past the light source spot 82. Based on this knowledge of the light source spot size, S, and the position of the lens 42 relative-to the focal length, an appropriate error signal can be created to adjust the position of the objective focus lens 42 if desired.

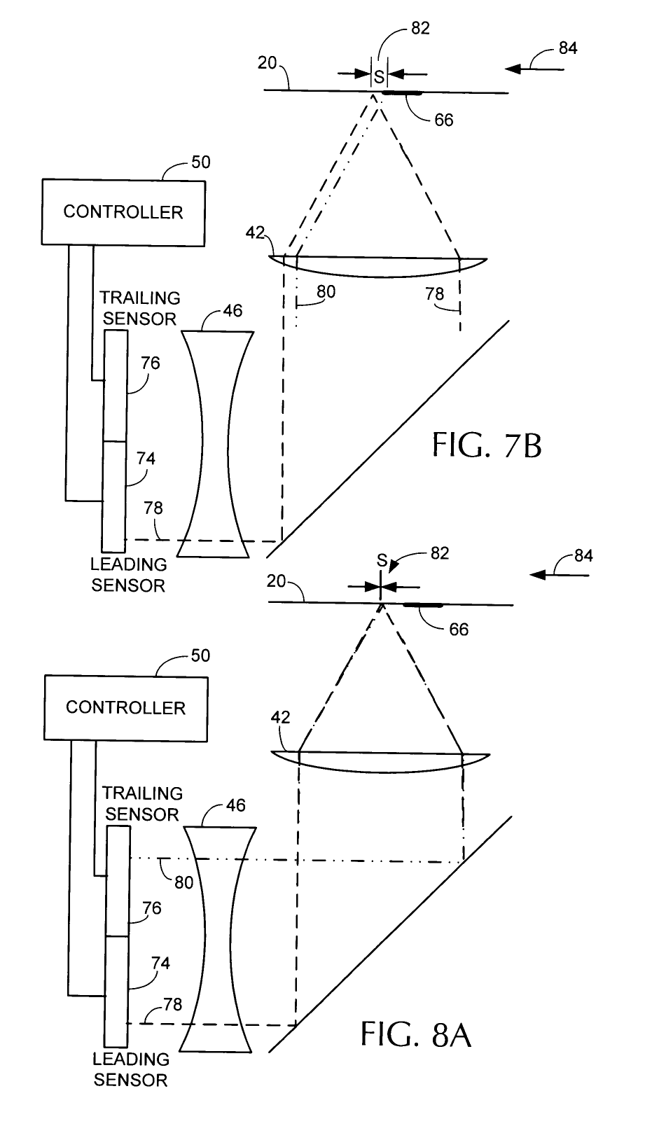

The embodiment illustrated in FIG. 7A is similar to FIG. 6A, with the difference that the distance from the objective focus lens 42 to the storage media 20 is greater than the focal length of the lens 42. As a result the light source spot 82 is inverted on the storage media 20. This can be determined when the feature of reflectivity change 66 passes under the light source beam 82 as illustrated in the embodiment of FIG. 7B. In this case, where the feature of reflectivity change 66 has come into contact with light source spot 82, the non-reflective nature of the feature of reflectivity change 66 causes a change in the measured light signal present at the trailing photo sensor 76, prior to any change in the measured light signal present at the leading photo sensor 74. This indicates that the light source spot 82 is inverted, and therefore the objective focus lens 42 is farther from the storage media 20 than the focal length of the lens 42. The size, S, of the light source spot 82 may be determined by dividing the time between sensed reflectivity change of the trailing photo sensor 76 and reflectivity change of the leading photo sensor 74 by the velocity of the storage media 20 past the light source spot 82. Based on this knowledge of the light source spot size, S, and the position of the lens 42 versus the focal length, an appropriate error signal can be created to adjust the position of the objective focus lens 42 if desired.

At some point while adjusting the distance of the objective focus lens 42 relative to the storage media 20, the feature of reflectivity change 66 may lie substantially at the focal length distance of the objective focus lens 42. At this point, as schematically illustrated in the embodiment of FIG. 8A, the light source spot 82 is substantially minimized in size. When the feature of reflectivity change 66 comes into contact with the light source spot 82, as illustrated in FIG. 8B, the non-reflective nature of the feature of reflectivity change 66 causes a change in the measured light signals present at both the leading photo sensor 74 and the trailing photo sensor 76 at substantially the same time. This indicates that the spot size, S, is substantially minimized.

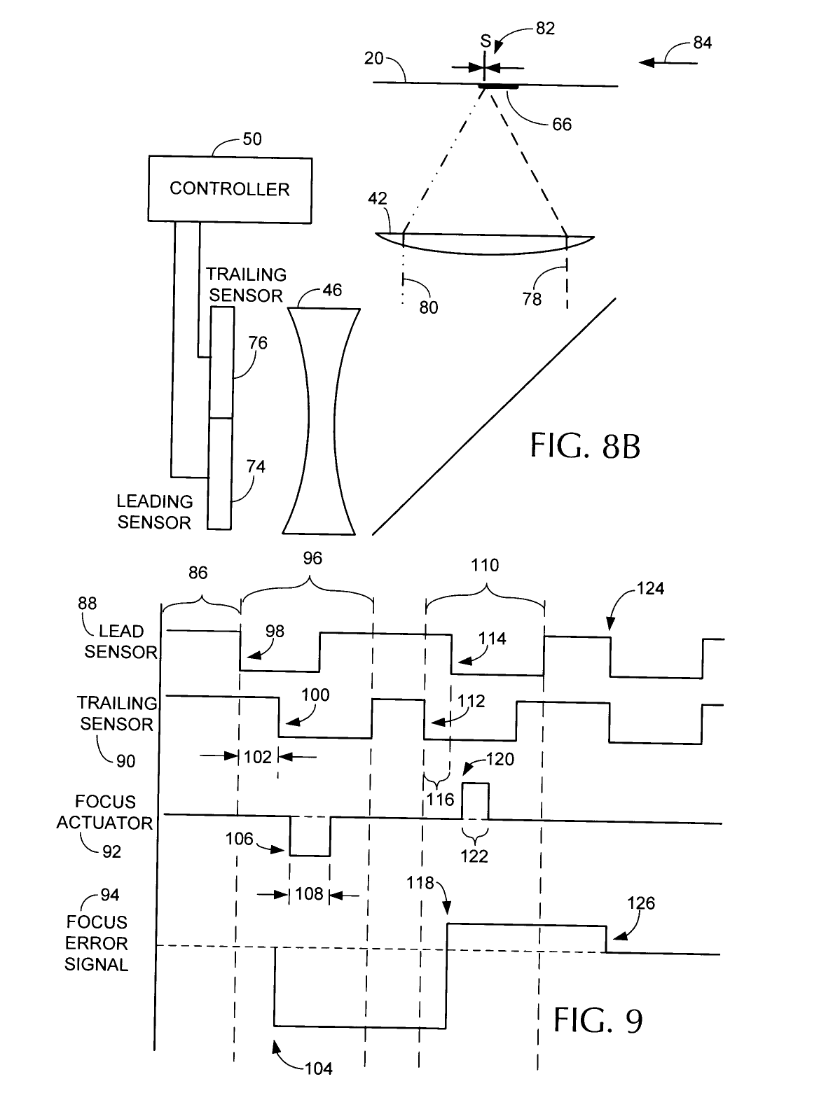

FIG. 9 schematically illustrates one embodiment of timing signals within a storage media drive using the concepts in the embodiments of FIGS. 6A-8B. During a first time period 86, the lead sensor signal 88 and the trailing sensor signal 90 are both showing steady levels of reflectivity. The focus actuator signal 92 indicates that the focus actuator is not being activated, and a focus error signal 94 is either indeterminate or can be assumed to be zero.

During a second time period 96, the lead sensor experiences a change in reflectivity 98 prior to the trailing sensor experiencing a change in reflectivity 100. Since the lead sensor experienced a change first, the objective lens is too close compared to the focal length of the lens. The time 102 between the reflectivity change of the lead sensor and the trailing sensor produces a negative 104 focus error signal 94 proportional to the time between changes. The focus actuator signal 92 is then activated in a negative direction 106 for a period of time 108 designed to move the objective focus lens away from the storage media. During a third time period 110, the trailing sensor experiences a change in reflectivity 112 prior to the leading sensor experiencing a change in reflectivity 114. Since the trailing sensor experienced a change first, the lens is too far compared to the focal length of the lens. The time 116 between the reflectivity change of the trailing sensor and the lead sensor produces a positive 118 focus error signal 94 proportional to the time between changes. The focus actuator signal 92 is then activated in a positive direction 120 for a period of time 122 designed to move the objective focus lens towards from the storage media 20.

At a fourth time period 124, both the lead sensor signal 88 and the trailing sensor signal 90 experience a change in reflectivity at substantially the same time. This indicates that the focused spot size is substantially minimized, and the focus error signal drops 126 to zero. In this embodiment, since it was desired to minimize the focused spot size, once the focus error signal reaches zero or a value sufficiently close to zero, the focus actuator does not need to be activated.

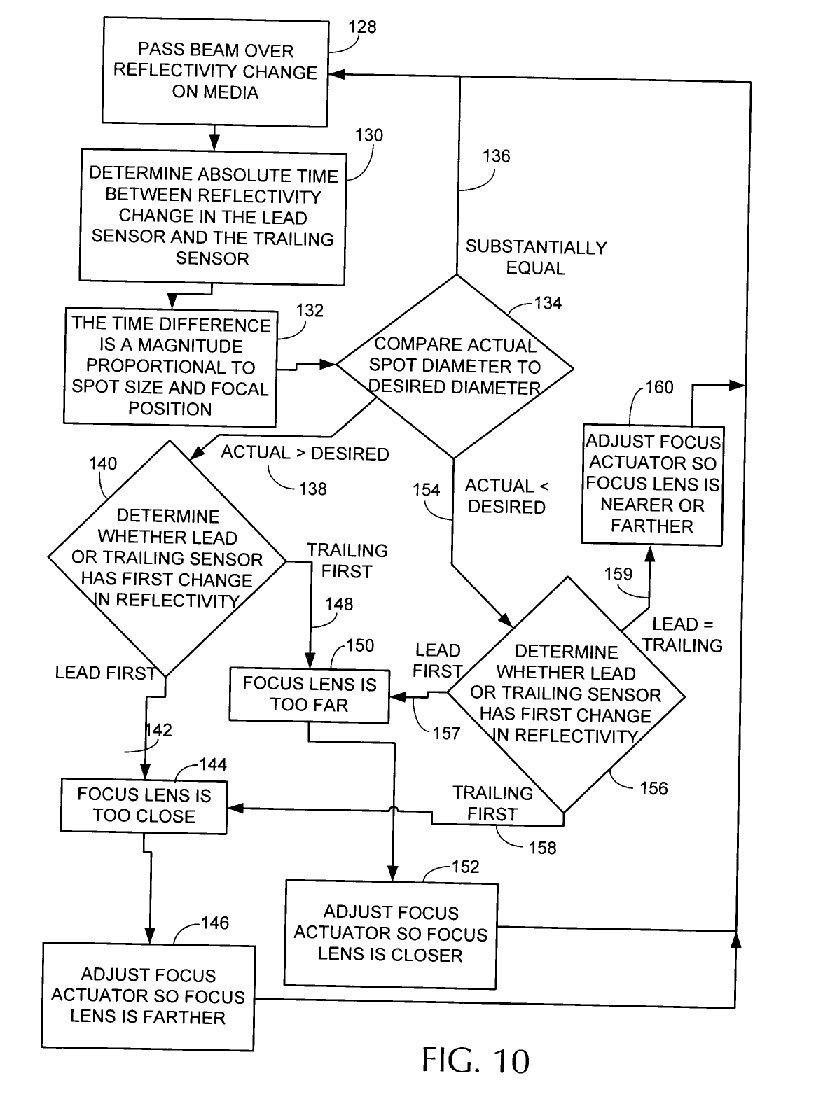

FIG. 10 illustrates one embodiment of actions which may be used to achieve a desired focus position. A light source beam is passed 128 over a reflectivity change on a storage media. The absolute time difference may be determined 130 between a reflectivity change in the leading photo sensor and the trailing photo sensor. This time difference is a magnitude 132 which is proportional to the spot size and the focal position. A comparison 134 is made between the actual magnitude and a desired magnitude. Since the magnitude is proportional to the spot size and the focal position, a proportionality constant may be arrived at by those skilled in the art, depending on the attributes of the optical path and the width of the photo sensor to relate the amplitude to a spot size using the velocity of the storage media relative to the light spot and the magnitude. If the actual magnitude is substantially equal to the desired magnitude 136 (within an acceptable margin of error or tolerance), then no adjustment is necessary. If the actual magnitude is greater than the desired magnitude 138, then a determination is made 140 whether the trailing sensor or the lead sensor was the first to experience a change in reflectivity. If the lead sensor experienced the change first 142, then the focus lens is too close 144, and the focus actuator may be adjusted 146 so that the focus lens is farther from the storage media. If the trailing sensor experienced the change first 148, then the focus lens is too far 150, and the focus actuator may be adjusted 152 so the focus lens is closer to the storage media. After adjusting the focus actuator 146, 152, the process can be repeated by starting with passing 128 a light source beam over a reflectivity change on a storage media.

Back at comparison action 134, where the actual spot diameter was compared 134 to the desired spot diameter, if the actual spot diameter is less than the desired spot diameter 154, then a determination is made 156 of whether the leading or trailing sensor had the first reflectivity change. If the leading sensor experienced the first reflectivity change 157, then the focus lens is too far 150, and the focus actuator may be adjusted 152 so that the focus lens is closer to the storage media. If the trailing sensor experienced the first reflectivity change 158, then the focus lens is too close 144, and the focus actuator may be adjusted 146 so that the focus lens is farther from the storage media. In some cases, when the actual spot diameter is less than 154 the desired spot diameter, the leading and trailing sensors may experience a change in reflectivity at substantially the same time 159. Since this indicates a substantially minimum spot size, the focus actuator may be adjusted 160 so that the focus lens is moved either nearer or farther from the storage media. Once the adjustments 146, 152, or 160 have been made to the focus actuator, the process may be repeated, starting with passing 128 a light source beam over a reflectivity change on a storage media.

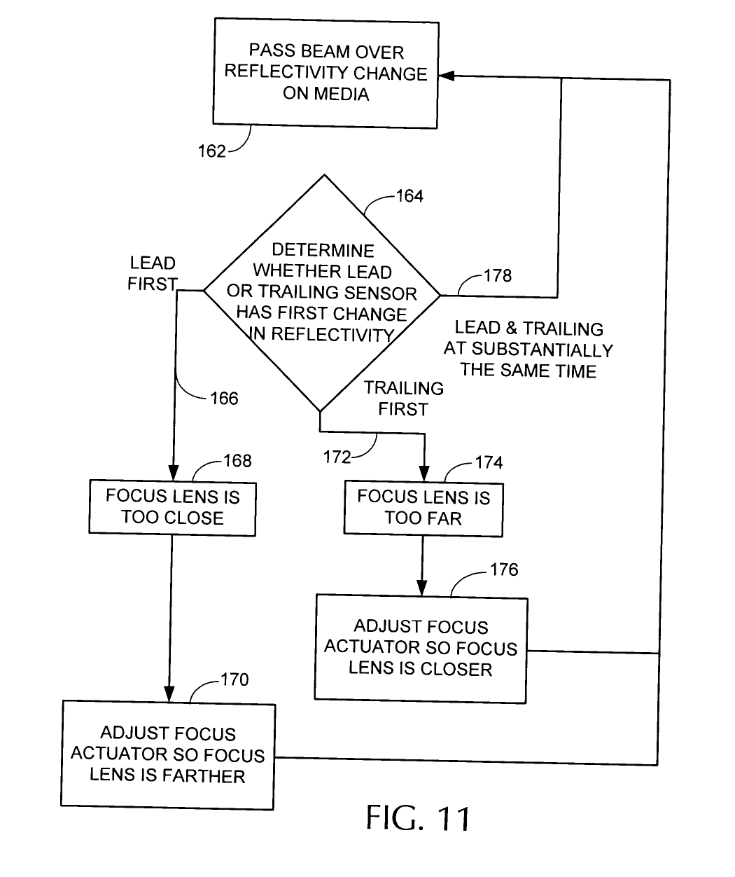

FIG. 11 illustrates one embodiment of actions which may be used to achieve a substantially minimized spot size on a storage media. While the embodiment of FIG. 10 may also be used to obtain a minimized spot size, provided the minimum spot size is known, the embodiment in FIG. 11 requires fewer steps and no knowledge of the minimum spot size in order to substantially minimize the spot size. A beam may be passed 162 over a reflectivity change on a storage media. A determination 164 is made whether the lead or the trailing sensor has experienced the first change in reflectivity. If the lead sensor has experienced the first change in reflectivity 166, then the focus lens is too close 168, and the focus actuator may be adjusted 170 so the focus lens is farther from the storage media. If the trailing sensor has experienced the first change in reflectivity 172, then the focus lens is too far 174, and the focus actuator may be adjusted 176 so that the focus lens is closer to the storage media. A determination may alternatively be made that the leading and trailing sensors experienced a change at substantially the same time 178. If this is the case, the focus spot size has been substantially minimized. Whether adjustments 170 or 176 are made to the focus actuator, or not made 178, the process can be repeated as desired.

The ability to derive a focus error signal in a storage media drive for focus control, without needing to rely on quadrature astigmatic error detection, enables label-side media storage reading and/or writing, as well as imaging of a light and/or heat activated color structure in the label layer without significant redesign of existing storage media drive architectures. Due to possible differences in spherical aberration which may be present when using a light source from the label side of a storage media, the data spot size which could be written to or read from the storage media may be limited when compared to the spot size available when operating a light source from the data side. The spot size available from the label side, however, could be adjusted to provide a suitable resolution for imaging a visible image on the label layer. A storage media apparatus could accept a storage media in a first orientation whereby the data side of the storage media is facing a light source for data reading and/or writing. The storage media could then be ejected and reinstalled in a second orientation whereby the label side of the storage media is facing the light source for label imaging. Some data reading and/or writing could also be done while the storage media is in this second orientation. Alternatively, a storage media apparatus could be designed with multiple light sources such that at least one light source could be focused on the data side of the storage media, while at least one other light source could be simultaneously or alternately focused on the label side of the storage media. In other alternatives, a storage media apparatus could be designed to have an optic path that allowed a single light source to be selectively focused on the label side or the data side of a storage media without the need to alter the orientation of the storage media.

A range of other benefits have been discussed above. The optical path architecture illustrated in the embodiments is not meant to be limiting, as other functionally equivalent optical paths may be envisioned. The methods described herein, and their equivalents may be practiced in an astigmatic system or a non-astigmatic system. The illustrated photo sensor of the embodiments was described as a quad-photo sensor. The methods described herein, and their equivalents may be practiced with a dual-site photo sensor or any multiple-segment photo sensor. Additionally, it is apparent that a variety of other structurally and functionally equivalent modifications and substitutions may be made to implement focus error signal generation according to the concepts covered herein, depending upon the particular implementation, while still falling within the scope of the claims below.

1. A method of focus control, comprising:
passing a light source beam over a reflectivity change on a storage media and on to a leading photo sensor and a trailing photo sensor;
determining whether the leading photo sensor or the trailing photo sensor had a first change in reflectivity;
if the leading sensor experienced the first change in reflectivity, then adjusting a focus actuator to move a focus lens farther from the storage media; and
if the trailing sensor experienced the first change in reflectivity, then adjusting the focus actuator to move the focus lens closer to the storage media.

2. The method of claim 1, further comprising:
if the trailing sensor and the leading sensor experienced a change in reflectivity at substantially the same time, then leaving the focus lens in a current location.

3. The method of claim 1, wherein the storage media is selected from the group consisting of compact discs and digital versatile discs.

4. The method of claim 1, wherein the storage media is a removable storage media.

5. The method of claim 1, wherein the storage media is a non-removable storage media.

6. The method of claim 1, wherein the leading photo sensor comprises a first set of multiple photo sensor segments.

7. The method of claim 6, wherein the trailing photo sensor comprises a second set of multiple photo sensor segments.

8. The method of claim 1, wherein:
the leading photo sensor comprises a first pair of photo sensors from a quadrature photo sensor; and
the trailing photo sensor comprises a second pair of photo sensors from the quadrature photo sensor.

9. A method of focus control, comprising:
passing a light source beam over a reflectivity change on a storage media and on to a leading photo sensor and a trailing photo sensor;
determining an absolute time between a reflectivity change in the leading and trailing photo sensors;
determining an actual magnitude proportional to a spot size and a focal position from the absolute time; and
comparing the actual magnitude to a desired magnitude.

10. The method of claim 9, wherein calculating the actual magnitude from the absolute time between the reflectivity change and the velocity of the storage media comprises dividing the absolute time by a velocity of the storage media.

11. The method of claim 10, wherein the velocity of the storage media comprises a relative velocity between the storage media and the light source beam.

12. The method of claim 9, further comprising:
if the actual magnitude is greater than the desired magnitude, determining whether the leading photo sensor or the trailing photo sensor experienced a first reflectivity change.

13. The method of claim 12, further comprising:
if the leading photo sensor experienced the first reflectivity change, then adjusting a focus actuator so a focus lens is moved farther from the storage media; and
if the trailing photo sensor experienced the first reflectivity change, then adjusting the focus actuator so the focus lens is moved closer to the storage media.

14. The method of claim 9, further comprising:
if the actual magnitude is less than the desired magnitude, determining whether the leading photo sensor or the trailing photo sensor experienced a first reflectivity change.

15. The method of claim 14, further comprising:
if the leading photo sensor experienced the first reflectivity change then adjusting a focus actuator so a focus lens in moved closer to the storage media;
if the trailing photo sensor experienced the first reflectivity change, then adjusting the focus actuator so the focus lens is moved farther from the storage media; and
if the trailing photo sensor and the leading photo sensor experienced a reflectivity change a substantially the same time, adjusting the focus actuator so that the focus lens is moved closer to the storage media.

16. The method of claim 14, further comprising:
if the leading photo sensor experienced the first reflectivity change then adjusting a focus actuator so a focus lens in moved closer to the storage media;
if the trailing photo sensor experienced the first reflectivity change, then adjusting the focus actuator so the focus lens is moved farther from the storage media; and
if the trailing photo sensor and the leading photo sensor experienced a reflectivity change a substantially the same time, adjusting the focus actuator so that the focus lens is moved farther from the storage media.

17. A method of focus error signal generation, comprising scaling a focus error signal in proportion to a difference in time between a leading photo sensor reflectivity change and a trailing photo sensor reflectivity change caused by a feature of reflectivity change on a storage media.

18. A method of imaging a label layer on a storage media, comprising:
generating a focus error signal using the method of claim 17;
adjusting a focus actuator to obtain a desired focus spot size relative to the focus error signal; and
selectively turning a light source on over areas of the label layer which are sensitive to the light source to produce a visible image on the image layer.

19. The method of claim 18, wherein the storage media is selected from the group consisting of compact discs and digital versatile discs.

20. A storage media apparatus, comprising:
a focus lens;
a focus actuator coupled to the focus lens;
a light source configured to emit a light beam through the focus lens onto a storage media;
a photo sensor configured to produce:
a leading signal responsive to a leading edge of the light beam; and
a trailing signal responsive to a trailing edge of the light beam; and
a controller coupled to the leading signal and the trailing signal.

21. The storage media apparatus of claim 20, wherein the storage media is selected from the group consisting of a compact disc and a digital versatile disc.

22. The storage media apparatus of claim 20, wherein the light source is further configured to emit the light beam through the focus lens onto a label side of the storage media.

23. The storage media apparatus of claim 20, wherein the storage media is permanently housed in the storage media apparatus.

24. The storage media apparatus of claim 20, wherein the storage media is removeably housed in the storage media apparatus.
